(19) United States
(12) Patent Application Publication
(10) Pub. No.: US 2018/0048817 A1
(43) Pub. Date: Feb. 15, 2018

(54) SYSTEMS AND METHODS FOR REDUCED POWER CONSUMPTION VIA MULTI-STAGE STATIC REGION DETECTION

(71) Applicant: QUALCOMM Incorporated, San Diego, CA (US)

(72) Inventors: Suolong Dong, San Diego, CA (US); Scott Cheng, Foothill Ranch, CA (US); Jeffrey Chu, San Diego, CA (US); Neil Christanto, Sunnyvale, CA (US); Joseph Cheung, San Diego, CA (US); Michael Lee Coulter, San Diego, CA (US); Chia-Yuan Teng, San Diego, CA (US); Haoping Xu, North York, CA (US)

(21) Appl. No.: 15/237,413

(22) Filed: Aug. 15, 2016

(51) Int. Cl. H04N 5/232; H04N 1/21; G06K 9/62; H04N 19/132; G06T 1/20; G06T 3/40

(52) U.S. Cl. CPC H04N 5/23241; H04N 5/23293; G06T 1/20; G06T 3/4015; G06K 9/6202; H04N 19/132; H04N 1/2112; G06T 2207/10024

(57) ABSTRACT

Methods and apparatus improve static region detection in an imaging pipeline. An imaging pipeline may perform detection of static regions of an image at multiple stages of the pipeline. For example, as static regions may be eliminated from further processing by the imaging pipeline, static region detection performed at an early stage of the pipeline may provide for maximized power savings. As images early in the pipeline may contain artifacts inhibiting detection of some static regions, additional static region detection may be performed after further image processing. For example, static region detection may be performed for a second time after some filtering is applied to images in the pipeline. Regions previously characterized as dynamic may be characterized as static later in the pipeline due to a reduction of noise for example provided by the filters, and differences between the static region detection at different positions within the imaging pipeline.

### BACKGROUND

Conventional image processing consumes substantial amounts of power. For example, in some implementations an imaging sensor may periodically record an image of a scene at a frame rate of thirty (30) frames per second (e.g., for video). In some embodiments, such image capture may be accomplished via a Bayer engine. After capture, an entire image may be written to memory, which also consumes power. The image may be read back from memory and post-processed by fixed function hardware or a GPU in some aspects to improve the quality of the image, for example, via filtering. This step also consumes substantial power. Finally, the filtered image may be encoded by a jpeg or video engine, and written to memory again, further consuming power. As the need for extended operation use cases have emerged for imaging device platforms, there is a need to acquire images at substantially reduced power consumption when compared to current methods.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include reduced power consumption in an imaging pipeline.

One aspect disclosed is a method for reducing power consumption of an imaging pipeline in an imaging device. The method includes characterizing, via an electronic hardware processor utilizing a first static region detection method, each of a plurality of regions of first imaging data as either static or dynamic, processing the dynamic regions of first imaging data while abstaining from processing the static regions of first imaging data to generate second imaging data, characterizing, via the electronic hardware processor using a second static region detection method different from the first static region detection method, each of a second plurality of regions of second imaging data as either static or dynamic, processing the dynamic regions of second imaging data while abstaining from processing the static regions of second imaging data to generate third imaging data; and writing data derived from the third imaging data to an output device.

In some aspects of the method, writing the data derived from the third imaging data to an output device includes displaying the data derived from the third imaging data to an electronic display or writing the data derived from the third imaging data to a stable storage device. In some aspects of the method, processing the dynamic regions of first imaging data includes generating second imaging data as Bayer format data by performing Bayer space processing on the dynamic regions of first imaging data. In some aspects of the method, processing the dynamic regions of second imaging data includes generating third imaging data as RGB data by performing demosaicing on the dynamic regions of second imaging data. In some aspects of the method, characterizing each of the plurality of regions of first imaging data as either static or dynamic includes aggregating differences between corresponding pixels in the region data and a corresponding region in other imaging data and comparing the aggregated differences to a first threshold. In some aspects of the method, the region is characterized as dynamic in response to the aggregated differences exceeding the threshold and the region is characterized as static in response to the aggregated differences being below the first threshold.

In some aspects of the method, characterizing a second region of the second plurality of regions as static or dynamic includes aggregating differences between corresponding pixels in the second imaging data and second other imaging data and comparing the aggregated differences to a second threshold different from the first threshold. In some aspects of the method, characterizing a second region of the second plurality of regions as static or dynamic includes generating a first signature based on data within the second region, generating a second signature based on data within a third region of other imaging data corresponding to the second region, and characterizing the second region as dynamic in response to the first signature being different from the second signature and as static in response to the first signature and second signatures being equivalent. In some aspects of the method, the first and second signatures are generated via a multiple-input signature register (MISR) method. In some aspects of the method, characterizing a second region of the second plurality of regions as static or dynamic includes identifying keypoints in the second region, identifying keypoints in a third region of other imaging data corresponding to the second region, correlating the first and second keypoints, and characterizing the second region as static or dynamic based on differences in one or more of relative positions and pixel values of the correlated keypoints. In some aspects of the method, processing the dynamic regions of the first imaging data includes Bayer processing of the dynamic regions and processing the dynamic regions of the second imaging data includes demosaicing of the dynamic regions of the second imaging data. In some aspects of the method, processing the dynamic regions of the first imaging data includes RGB space processing of the dynamic regions and processing the dynamic regions of the second imaging data includes YUV space processing of the dynamic regions of the second imaging data.

Another aspect disclosed is an imaging device providing for reduced power consumption of an imaging pipeline. The device includes an electronic hardware processor, configured to characterize, using a first static region detection method, each of a plurality of regions of first imaging data as either static or dynamic, process the dynamic regions of first imaging data while abstaining from processing the static regions of first imaging data to generate second imaging data, characterize, using a second static region detection method different from the first static region detection method, each of a second plurality of regions of second imaging data as either static or dynamic, process the dynamic regions of second imaging data while abstaining from processing the static regions of second imaging data to generate third imaging data. And write data derived from the third imaging data to an output device. In some aspects of the device, the electronic hardware processor is further configured to write the data derived from the third imaging data to an output device by displaying the data derived from the third imaging data to an electronic display or by writing the data derived from the third imaging data to a stable storage device. In some aspects of the device, the electronic hardware processor is further configured to process the dynamic regions of first imaging data by performing Bayer space processing on the dynamic regions of first imaging data and generating second imaging data as Bayer format data.

In some aspects of the device, the electronic hardware processor is further configured to characterize the dynamic regions of second imaging data by performing demosaicing on the dynamic regions of second imaging data and generating third imaging data as RGB data. In some aspects of the device, the electronic hardware processor is further configured to characterize each of the plurality of regions of first imaging data as either static or dynamic by aggregating differences between corresponding pixels in the region data and a corresponding region in other imaging data and comparing the aggregated differences to a first threshold. In some aspects of the device, the electronic hardware processor is further configured to characterize the region as dynamic in response to the aggregated differences exceeding the threshold and characterize the region as static in response to the aggregated differences being below the first threshold. In some aspects of the device, the electronic hardware processor is further configured to characterize a second region of the second plurality of regions as static or dynamic by aggregating differences between corresponding pixels in the second imaging data and second other imaging data and comparing the aggregated differences to a second threshold different from the first threshold. In some aspects of the device, the electronic hardware processor is further configured to characterize a second region of the second plurality of regions as static or dynamic by generating a first signature based on data within the second region, generating a second signature based on data within a third region of other imaging data corresponding to the second region, and characterizing the second region as dynamic in response to the first signature being different from the second signature and as static in response to the first signature and second signatures being equivalent.

In some aspects of the device, the electronic hardware processor is further configured to generate the first and second signatures via a multiple-input signature register (MISR) method. In some aspects of the device, the electronic hardware processor is configured to characterize a second region of the second plurality of regions as static or dynamic by identifying keypoints in the second region, identifying keypoints in a third region of other imaging data corresponding to the second region, correlating the first and second keypoints, and characterizing the second region as static or dynamic based on differences in one or more of positions, and pixel values of the correlated keypoints. In some aspects of the device, processing the dynamic regions of the first imaging data includes Bayer processing of the dynamic regions and wherein processing the dynamic regions of the second imaging data includes demosaicing of the dynamic regions of the second imaging data. In some aspects of the device, processing the dynamic regions of the first imaging data includes RGB space processing of the dynamic regions and wherein processing the dynamic regions of the second imaging data includes YUV space processing of the dynamic regions of the second imaging data.

Another aspect disclosed is a non-transitory computer readable media including instructions that when executed cause an electronic hardware processor to perform a method of reducing power consumption by an imaging pipeline in an imaging device, the method including characterizing, via an electronic hardware processor utilizing a first static region detection method, each of a plurality of regions of first imaging data as either static or dynamic, processing the dynamic regions of first imaging data while abstaining from processing the static regions of first imaging data to generate second imaging data, characterizing, via the electronic hardware processor using a second static region detection method different from the first static region detection method, each of a second plurality of regions of second imaging data as either static or dynamic, processing the dynamic regions of second imaging data while abstaining from processing the static regions of second imaging data to generate third imaging data, and writing data derived from the third imaging data to an output device.

In some aspects of the non-transitory computer readable media, characterizing each of the plurality of regions of first imaging data as either static or dynamic includes aggregating differences between corresponding pixels in the region data and a corresponding region in other imaging data and comparing the aggregated differences to a first threshold. In some aspects of the non-transitory computer readable media, the method further includes characterizing the region as dynamic in response to the aggregated differences exceeding the threshold and characterizing the region as static in response to the aggregated differences being below the first threshold. In some aspects of the non-transitory computer readable media, characterizing a second region of the second plurality of regions as static or dynamic includes aggregating differences between corresponding pixels in the second imaging data and second other imaging data and comparing the aggregated differences to a second threshold different from the first threshold.

In some aspects of the non-transitory computer readable media, characterizing a second region of the second plurality of regions as static or dynamic includes generating a first signature based on data within the second region, generating a second signature based on data within a third region of other imaging data corresponding to the second region, and characterizing the second region as dynamic in response to the first signature being different from the second signature and as static in response to the first signature and second signatures being equivalent. In some aspects of the non-transitory computer readable media, the method further includes generating the first and second signatures via a multiple-input signature register (MISR) method. In some aspects of the non-transitory computer readable media, characterizing a second region of the second plurality of regions as static or dynamic includes identifying keypoints in the second region, identifying keypoints in a third region of other imaging data corresponding to the second region, correlating the first and second keypoints, and characterizing the second region as static or dynamic based on differences in one or more of relative positions and pixel values of the correlated keypoints.

### BRIEF DESCRIPTION OF THE DRAWINGS

The various features illustrated in the drawings may not be drawn to scale. Accordingly, the dimensions of the various features may be arbitrarily expanded or reduced for clarity. Furthermore, dotted or dashed lines and objects may indicate optional features or be used to show organization of components. In addition, some of the drawings may not depict all of the components of a given system, method, or device. Finally, like reference numerals may be used to denote like features throughout the specification and figures.

FIG. 1 illustrates a schematic of an example of an image processing pipeline including aspects of the disclosed embodiments.

FIG. 2 illustrates a previous frame and a current frame in an example embodiment of static region detection.

FIG. 3 illustrates an example of a portion of the image pipeline of FIG. 1, along with a corresponding graph indicating an exemplary amount of data processed by stages of the image pipeline.

FIG. 4 illustrates a block diagram of one example of an apparatus implementing the disclosed embodiments.

FIG. 5 is a flowchart of a method of detecting static regions in an image pipeline and therefore saving power.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect disclosed herein may be embodied by one or more elements of a claim.

Furthermore, although particular aspects are described herein, many variations and permutations of these aspects fall within the scope of the disclosure. In addition, the scope of the disclosure is not intended to be limited to particular the benefits, uses, or objectives disclosed herein. Rather, aspects of the disclosure are intended to be broadly applicable to different wired and wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

As discussed above, image capture and the associated processing can consume substantial amount of power, reducing battery life. This power consumption can be significant even when the images being captured are relatively static in nature. For example, if an imaging device is placed on a stationary tripod, desk, or mounted to a wall, there is a relatively high probability that consecutive images are static or at least quite similar. However, in traditional implementations, each of the consecutive images may be processed as described above. For example, in traditional implementations, the entirety of each repetitive image may be written at least twice to memory, first after an initial capture and for a second time after processing.

To support longer battery life when performing imaging processing of images including at least some static portions, the methods and systems disclosed provide for multiple image static region detectors (ISRDs) in an image processing pipeline. The ISRDs detect static regions in a current frame relative to a previous frame. Once a particular region of an image is determined to be static, further processing of that region by the imaging pipeline may generally be avoided to save power and imaging pipeline bandwidth. Avoiding processing may prevent for example, reading or saving that region to a memory or stable storage, as well as avoiding image processing operations, such as demosaicing, on those static regions. In the disclosed methods and systems, an ISRD may be placed before or after any Image Signal Processor (ISP) module in either a Bayer domain or YUV domain, or both domains.

The use of multiple ISRD's may result in reduced power consumption by the image processing pipeline when at least portions of the images being captured are static in nature. Power consumption reduction may be linear with respect to workload. The fewer pixels processed, the less energy consumed. In addition, memory bandwidth may be favorably impacted, due to a reduction in the amount of data being written to the memory. For example, by referencing previous imaging frames for regions of an image judged to be static, there is no need to write static regions of subsequent frames to memory. Further power reduction is realized because less data may be processed by a video encoder. For example, some video codec standards provide for frame skipping. The static region detectors may facilitate increased utilization of such frame skipping features. In some aspects, image processing of static regions is provided randomly to avoid plasticity effects which might otherwise result from the display of continuous static images.

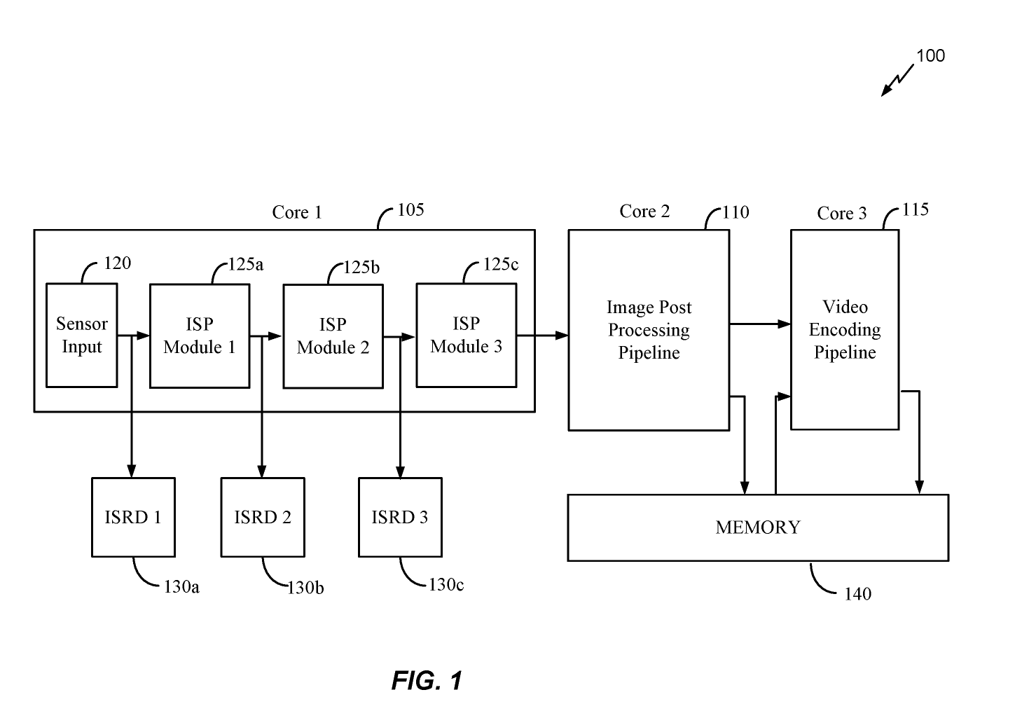

FIG. 1 shows an exemplary image processing pipeline including aspects of the disclosed embodiments. The image processing pipeline 100 is composed of three main components, core 1 105, core 2 110, and core 3 115. Component core 1 105 is shown to include input received from a sensor 120, and three ISPs 125a-c. Output data of the first ISP 120a provides input data to the second ISP 120b. Output data of the second ISP 120b provides input data for the third ISP 120c. Component core 1 105 generates output data that is used as input data for component core 2 110. Component core 2 110 generates output data that provides input data for core 3 115. Component core 3 115 generates output data that may be stored in an electronic hardware memory 140.

FIG. 1 also shows three image static region detectors (ISRD) 130a-c. As illustrated, the ISRD's 130a-c are positioned between the sensor input 120a and first ISP module 125a, between the first ISP module 125a and second ISP module 125b, and between the second ISP module 125b and third ISP module 125c, respectively. Each of the ISRD's may detect one or more static regions within their respective input data. Upon detection of one or more static regions, each of the ISRD's 130a-c may generate a signal to downstream image processing components indicating they should exclude the detected static regions from further processing. In some aspects, when particular regions of an image are excluded, data for that region may be obtained from a previous frame.

As one example, a first frame may be processed by each component of the image pipeline 100, with results of the processing stored in the memory 140. A second subsequent frame may include one or more static regions relative to the first frame. Thus, instead of processing the one or more static regions further via the image pipeline 100, the processing of the second frame may rely on portions of the results of the processing of the first frame that correspond to the static regions of the second frame. These portions may be aggregated with non-static portions of the second frame to form a complete second frame, without the processing overhead required to process the static portions of the second frame, which may essentially result in equivalent results to the corresponding portions of the processed first frame.

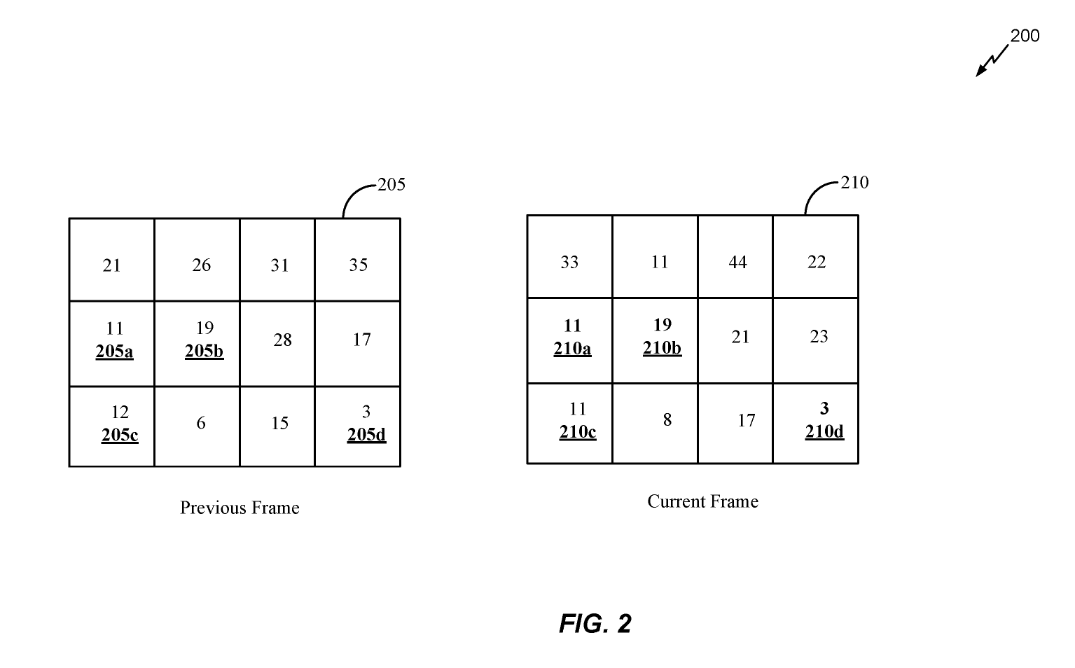

FIG. 2 shows an exemplary embodiment of static region detection. FIG. 2 shows two image frames 205 and 210. Frame 210 may be captured subsequent to frame 205. Each of the image frames 205 and 210 contain twelve (12) exemplary regions. More or less regions are contemplated by the present embodiments. The numbers within each of the regions represent a measurement of content within the region. The measurements may be generated by an aggregated differences method, multiple input Signature Register (MISR) method, or a keypoint method, all of which are discussed in more detail below. Equivalent measurements or nearly equivalent measurements from corresponding regions (when using some static detection methods) may indicate the region may be static between frame 205 and frame 210. As shown, each of regions 205a-b and 205d are static between frames 205 and 210 as their measurements are equivalent. The region represented by 205c and 210c may have different measurements for content, but a difference between the measurements may be below a threshold, such that some embodiments using certain static detection methods discussed below consider this region to be static. Other aspects may consider this region to be dynamic.

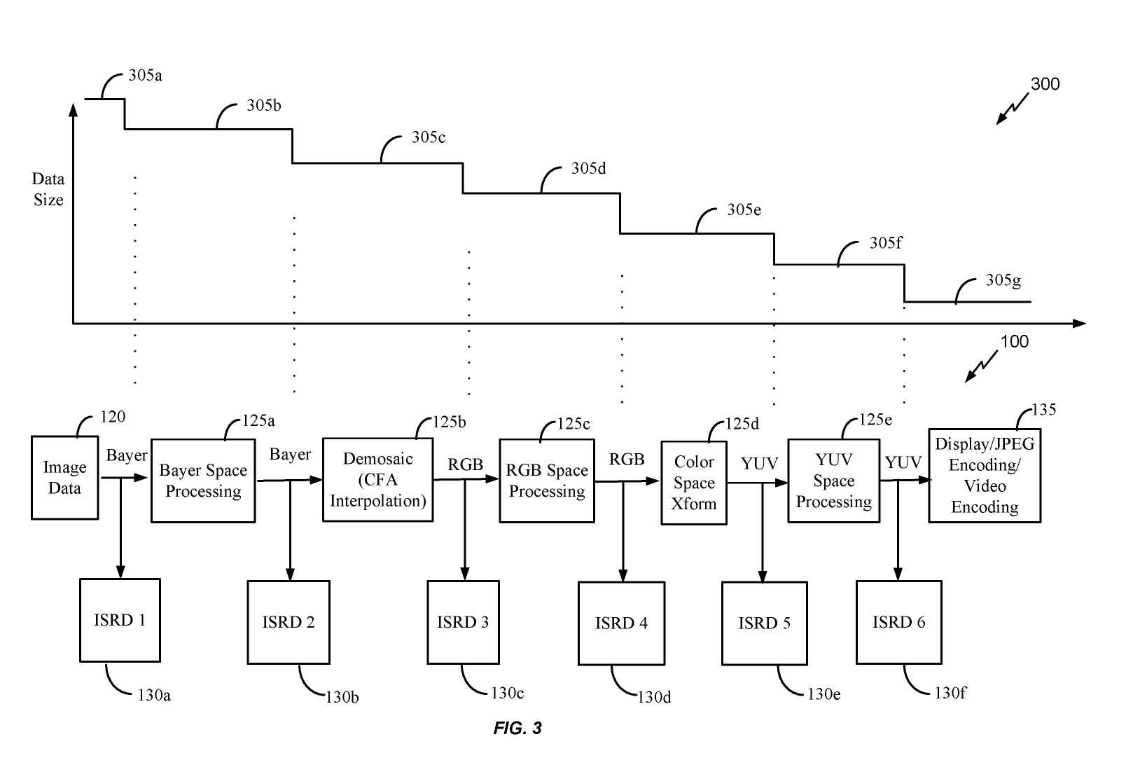

The other regions not discussed above are not labeled to preserve figure clarity, but the measurement for each of these regions can be observed to vary between frames 205 and 210, and thus these regions may be considered dynamic in at least some aspects. Each of the image static region detectors (ISRD's) 130a-c illustrated in FIG. 1, and/or the ISRD's 130a-f illustrated in FIG. 3 below may be configured to detect differences and equivalencies between regions in successive image frames processed by the image pipeline 100.

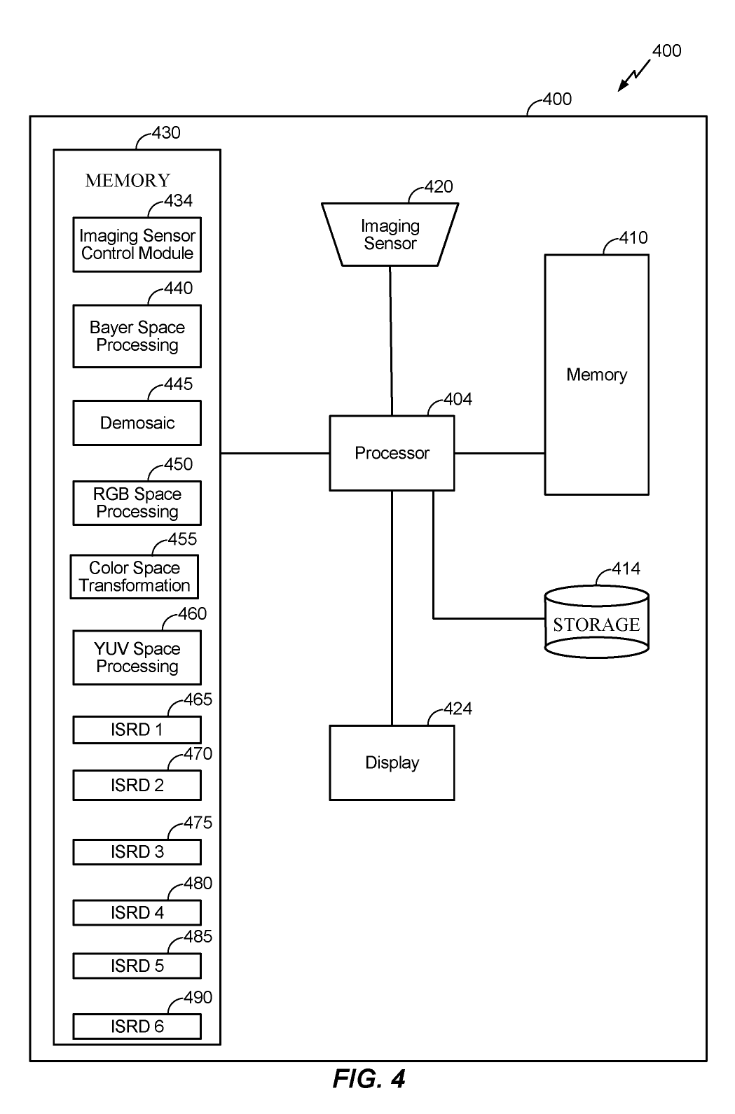

FIG. 3 illustrates an example of a portion of the image pipeline 100 of FIG. 1, along with a corresponding graph 300 indicating an amount of data or pixels in some aspects processed by stages of the image pipeline 100 in one exemplary embodiment. The graph 300 is not necessarily to scale. The image pipeline 100 may be configured to process a sequence of image frames captured by an image acquisition component, e.g., an imaging sensor (e.g., imaging sensor 420, FIG. 4). FIG. 3 shows that input data 120, which may have been acquired via the image acquisition component, such as an imaging sensor, is provided to both a Bayer space processing ISP 125a and a first ISRD 130a.

The Bayer space processing ISP 125 may perform bad pixel correction (BPC) which modifies pixel values that are determined to be erroneous. The modifications may be based on color information within a neighborhood of the erroneous pixel. For example, the neighborhood may include pixel values within one (1), two (2), three (3), four (4) or five (5) pixels of the erroneous pixel. A pixel may be determined to be erroneous if, for example, the pixel value is outside a predetermined range of values. The predetermined range of values may itself be based on, for example, a neighborhood of other pixel values adjacent to the pixel. For example, in some aspects, if a pixel value is two or more standard deviations from an average pixel value within a region, it may be determined to be erroneous. The size of the region may vary by embodiment, but may include pixels within one (1), two (2), or more pixels from the center of the region. The Bayer space processing ISP 125 may also perform noise reduction and/or filtering. In some aspects, the Bayer space processing ISP 125 may also perform Auto White Balance (AWB), which may remove unrealistic color casts, so that objects which appear white in person are rendered white in the image. For example, an auto white balance (AWB) algorithm of the Bayer space processing ISP 125 may modify color values of pixels in the image based on an estimated color temperature of the image.

The ISP 125a may receive Bayer data as input 120 and generate Bayer data as output. The first ISRD 130a may detect zero or more static regions within the sequence of image frames processed by the pipeline 100 and indicate to downstream components, such as one or more of ISPs 125a-e, ISRDs 130b-f, and encoder 135 to skip processing of the detected zero or more static regions. The Bayer space processing ISP 125a may be configured to selectively skip static regions detected by the ISRD 130a. This is shown in the graph 300 as a difference in the amount of data or pixels 305a and 305b. While the image data 120 may include an amount of data or pixels shown as 305a, the Bayer space processing ISP 125a may receive an amount of data or pixels 305b, with the difference representing the removal of one or more static regions detected by the ISRD 1 130a. In some aspects, the Bayer space processing ISP 125a may receive the same amount of data as provided in the image data 120, but may be configured to selectively skip one or more static regions detected by the ISRD 1 130a.

Output data generated by the Bayer space processing ISP 125a is provided to a demosaic ISP 125b and a second ISRD 130b. The demosaic ISP 125b may perform CFA interpolation or color reconstruction. For example, the demosaic ISP 125b may construct a full color image (Bayer format) from incomplete color samples that may have been generated by an image sensor overlaid with a Color Filter Array (CFA). Some aspects utilize a Bayer filter configuration including alternating red (R) and green (G) filters for every other row and alternating green (G) and blue (B) filters for the intervening rows. Therefore, in these implementations, there may be twice as many green (G) filters as red (R) or blue (B) filters. This design may accommodate the fact that human eyes are more sensitive to green light. In some aspects, incomplete color samples may be constructed by interpolation from neighboring pixel values. There are many different algorithms for CFA interpolation, and this may vary by embodiment. One method is known as nearest-neighbor interpolation. This method may copy an adjacent pixel of the same color channel to the pixel being reconstructed. Another method is bilinear interpolation which may calculate a red value of a non-red pixel as an average of some number (such as two or four) adjacent red pixels and similarly for blue and green. Other methods such as bicubic interpolation, spine interpolation, etc. can be employed in some aspects. After CFA interpolation, each pixel component may contain three pixel values which are red value, green value and blue value compared with a single value before CFA interpolation. Therefore, output from demosaic processing performed by ISP 125b may render images generated by the Bayer space processing ISP 125a into a viewable format. In some aspects, this is RGB format, as shown in FIG. 3.

Input data to ISRD 130b may be different than the input data received by ISRD 130a, in that the input data received by ISRD 130b has been processed by the ISP 125a whereas input data provided to ISRD 130a has not. Input data to ISRD 130a may contain a first level of noise as it may be obtained directly from an imaging sensor. This relatively large level (first level) of noise may make it more difficult to detect static regions of the image by ISRD 130a. In contrast, image data provided to second ISRD 130b may include less noise. Thus, the second ISRD 130b may be more likely to detect some static regions as the input data to 130b has been processed (denoising, bad pixel correction, etc as performed by the Bayer space processing ISP 125a) and may contain a second level of noise lower than the first level of noise present in the input data provided to ISRD 130a. The second ISRD 130b may detect zero or more static regions within a series of image frames processed by the image pipeline 100 and indicate to downstream components, such as one or more of ISPs 125b-e, ISRDs 130c-f, and encoder 135 to skip processing of the detected zero or more static regions. As such, the demosaic 125b ISP may be configured to selectively skip processing of static regions identified by one or more of the ISRDs 130a-b. This is shown by the difference in the amount of data or pixels 305b and 305c. While the Bayer space processing ISP 125a may output an amount of data or pixels represented by 305b, the demosaic ISP 125b may receive an amount of data or pixels 305c, with the difference representing the removal of one or more additional static regions detected by the ISRD 2 130b. In some aspects, the demosaic ISP 125b may receive the same amount of data as output by the Bayer space processing ISP 125a, but may be configured to selectively skip one or more static regions detected by the ISRD 2 130b.

The demosaic module 125b receives Bayer data and generates RGB data. The generated RGB data is provided to the RGB space processing ISP 125c and a third ISRD 130c. In contrast to the first and second ISRDs 130a-b, the third ISRD 130c is configured to receive RGB data from the demosaic ISP 125b and detect zero or more static regions within the sequence of frames processed by the image pipeline 100. The third ISRD 130c may indicate to downstream components, such as one or more of ISPs 125c-e, ISRDs 130d-f, and encoder 135 to skip processing of the detected zero or more static regions. This is shown by the difference in the amount of data or pixels 305c and 305d. While the demosaic ISP 125b may output an amount of data or pixels represented by 305c, the RGB Space processing ISP 125c may receive an amount of data or pixels 305d, with the difference representing the removal of one or more additional static regions detected by the ISRD 3 130c. In some aspects, the RGB space processing ISP 125c may receive the same amount of data as output by the demosaic ISP 125b, but may be configured to selectively skip one or more static regions detected by the ISRD 3 130c.

RGB space processing ISP 125c performs RGB space processing on the RGB data received from the demosaic ISP 125b. In some aspects, the RGB space processing ISP 125c may perform color correction (CC) so as to “tune” image colors so they replicate scene colors. The RGB space processing ISP 125c may also perform gamma correction which may be a nonlinear operation used to encode and decode luminance or tristimulus values. In some aspects, the gamma correction may operate according to the formula Vₒᵤₜ=AVᵢₙ^{γ}, where “A” is a constant and the input and output values are non-negative real values. In some aspects, “A” may be equivalent to one (1), and inputs and outputs may be in a value range of zero (0) and one (1).

The ISP 125c may be configured to selectively skip processing of static regions identified by one or more of the ISRDs 130a-c. The ISP 125c generates transformed RGB data as output data, which is provided to the color space transformation ISP 125d and a fourth ISRD 130d. While the third ISRD 130c is configured to process RGB data before the RGB space processing performed by ISP 125c, the fourth ISRD 130d is configured to process data after processing by the ISP 125c.

The CST ISP 125d may convert RGB pixel format received from the RGB space processing ISP 125c to YUV color space data. This YUV data may encode the color image data while taking human perception into account, as the human eye has fairly little spatial sensitivity to color: the accuracy of the brightness information of the luminance (Y) channel may have more impact on the perceived image detail than that of the other two chrominance channels (i.e. UV), allowing reduced bandwidth for chrominance components. This may enable transmission errors or compression artifacts to be more efficiently masked by human perception than when using a direct RGB-representation.

The fourth ISRD 130d may detect zero or more static regions within a series of image frames processed by the image pipeline 100 and indicate to downstream components, such as one or more of ISPs 125e-f, ISRDs 130d-f, and encoder 135 to skip processing of the detected zero or more static regions. This is shown at least in part by the difference in the amount of data or pixels 305d and 305e. While the RGB space processing ISP 125c may output an amount of data or pixels represented by 305d, the color space transformation ISP 125d may receive an amount of data or pixels 305e, with the difference representing the removal of one or more additional static regions detected by the ISRD 4 130d. In some aspects, the color space transformation ISP 125d may receive the same amount of data as output by the RGB space processing ISP 125c, but may be configured to selectively skip one or more static regions detected by the ISRD 4 130d and/or any of ISRDs 130a-c.

ISP 125e performs YUV space processing on the YUV data generated by the color space transformation ISP 125d. The YUV space processing ISP 125e may perform image stabilization (IS), which reduces image blurring associated with the motion of the imaging device during exposure. In some aspects, output data from image stabilization may be provided to a temporal filter (TF). The temporal filter may utilize data from one or more previous image frames to perform temporal denoising. This may improve video quality. In some aspects, gamma correction may be performed on the output of the temporal filter (TF). YUV space color corrections may also be performed. These functions are similar to RGB space gamma correction and color correction described above. In some aspects, an adaptive spatial filter (ASF) may be applied on the Y component of YUV pixels, resulting in reduced noise. After application of the adaptive spatial filter, scaling and sharpening of the image data may be performed.

The fifth ISRD 130e may detect zero or more static regions within a series of image frames processed by the image pipeline 100 and indicate to downstream components, such as one or more of ISPs 125e, ISRD 130f, and encoder 135 to skip processing of the detected zero or more static regions. This is shown at least in part by the difference in the amount of data 305e and 305f While the color space transformation ISP 125d may output an amount of data represented by 305e, the YUV space processing ISP 125e may receive an amount of data 305f, with the difference representing the removal of one or more additional static regions detected by the ISRD 5 130e. In some aspects, the YUV space processing ISP 125e may receive the same amount of data as output by the color space transformation ISP 125d, but may be configured to selectively skip one or more static regions detected by the ISRD 5 130e.

The YUV space processing ISP 125e receives YUV data generated by the color space transformation ISP 125d and also generates YUV format data, which is provided to both the encoding engine 135 and sixth ISRD 130f The sixth ISRD 130f may be configured to process the YUV data generated by the YUV space processing ISP 125e and detect zero or more static regions within successive frames. The sixth ISRD 130f may be configured to indicate to downstream components, such as the encoding engine 135 to skip processing of the detected zero or more static regions.

The encoding engine 135 may be configured to skip processing of static regions identified by one or more of ISRDs 130a-f. This is shown at least in part by the difference in the amount of data 305f and 305g. While the YUV space processing ISP 125e may output an amount of data represented by 305e, the encoding engine 135 may receive an amount of data 305f, with the difference representing the removal of one or more additional static regions detected by the ISRD 5 130f In some aspects, the encoding engine 135 may receive the same amount of data as output by the YUV space processing ISP 125e, but may be configured to selectively skip one or more static regions detected by the ISRD 6 130f.

Thus, as described above, in some aspects, a first image frame in an image frame sequence may be processed by every ISP module in the image processing pipeline 100. Additionally, each ISRD in the pipeline may store corresponding information/image data for this first frame for future comparison. As a second image frame in the image frame sequence is processed by the image processing pipeline 100, the ISRDs may compare the second frame with the stored information derived from the first frame to determine static and dynamic regions of the second frame. The previously stored image data from the first frame may also be replaced by image data of the second frame for regions determined to be dynamic in some aspects.

When the image pipeline 100 processes a third frame in the image frame sequence, an ISRD may compare regions of the third frame with stored information of the second frame. Stored information from the second frame may be replaced by corresponding information from the third frame. This process may repeat for n frames. As discussed above, if one or more regions of a current frame are determined to be static, ISPs and ISRDs following the point where the static nature of the region is detected may be configured to skip processing of the determined static regions. Instead, these processes may utilize corresponding regions from a previous frame.

FIG. 4 is a block diagram of one example of an apparatus implementing the disclosed embodiments. The apparatus 400 includes an electronic hardware processor 404, electronic hardware memory 410, storage 414, imaging sensor 420, display 424, and second electronic hardware memory 430. The apparatus 400 may implement the data flow discussed above with respect to FIG. 3 in some aspects.

The second electronic hardware memory 430 may store instructions that configure the processor 404 to perform functions. The instructions may be organized into a number of modules, grouped by functions the instructions may perform. In the illustrated example embodiment, the instructions are grouped into an imaging sensor control module 434, a Bayer space processing module 440, a demosaic module 445, a RGB space processing module 450, a color space transformation module 455, a YUV space processing module 460, a first ISRD module 465, a second ISRD module 470, a third ISRD module 475, a fourth ISRD module 480, a fifth ISRD module 485, and a sixth ISRD module 490.

Instructions in the imaging sensor control module 434 may configure the processor 404 to capture a sequence of images using the imaging sensor 420. The sequence of images may be processed by the image pipeline 100, discussed above, which may be implemented by portions of the device 400.

Instructions within the Bayer space processing module 440 may configure the electronic hardware processor 404 to perform Bayer space processing, as described above with respect to ISP 125a in FIG. 3. In some aspects, instructions in the Bayer space processing module 440 may be configured to skip processing of one or more static regions detected by one or more ISRD modules, discussed below.

Instructions in the demosaic module 445 may configure the electronic hardware processor 404 to perform demosaicing of the Bayer data provided by the Bayer space processing module 440, as described above with respect to ISP 125b in FIG. 3. In some aspects, instructions in the demosaic module 445 may be configured to skip processing of one or more static regions detected by one or more ISRD modules, discussed below.

Instructions in the RGB space processing module 450 may configure the electronic hardware processor 404 to perform RGB space processing of data provided by the demosaic module 445, as described above with respect to ISP 125c in FIG. 3. In some aspects, instructions in the RGB space processing module 450 may be configured to skip processing of one or more static regions detected by one or more ISRD modules, discussed below.

Instructions in the color space transformation module 455 may configure the electronic hardware processor 404 to perform color space transformation of data provided by the RGB space processing module 450, as described above with respect to ISP 125c in FIG. 3. In some aspects, instructions in the color space transformation module 455 may be configured to skip processing of one or more static regions detected by one or more ISRD modules, discussed below.

Instructions in the YUV space processing module 460 may configure the electronic hardware processor 404 to perform YUV space processing of the YUV processed data provided by the color space transformation module 455, as described above with respect to ISP 125d in FIG. 3. In some aspects, instructions in the YUV space processing module 460 may be configured to skip processing of one or more static regions detected by one or more ISRD modules, discussed below.

Instructions in the ISRD 1 module 465 may be configured to receive data generated by the imaging sensor 420 and detect zero or more static regions (e.g., detect zero static regions and/or detect more than zero static regions) in a sequence of images captured by the imaging sensor 420, and configure downstream components to selectively skip processing of the static regions, as discussed above for example, with respect to the first ISRD 130a of FIG. 3.

Instructions in the ISRD 2 module 470 may be configured to receive data generated by the Bayer space processing module 440 and detect zero or more static regions in a sequence of images, and configure downstream components to selectively skip processing of the static regions, as discussed above for example, with respect to the second ISRD 130b of FIG. 3.

Instructions in the ISRD 3 module 475 may be configured to receive data generated by the demosaic module 445 and detect zero or more static regions in a sequence of images, and configure downstream components to selectively skip processing of the static regions, as discussed above for example, with respect to the third ISRD 130c of FIG. 3.

Instructions in the ISRD 4 module 480 may be configured to receive data generated by the RGB space processing module 450 and detect zero or more static regions in a sequence of images, and configure downstream components to selectively skip processing of the static regions, as discussed above for example, with respect to the fourth ISRD 130d of FIG. 3.

Instructions in the ISRD 5 module 485 may be configured to receive data generated by the Color Space Transformation module 455 and detect zero or more static regions in a sequence of images, and configure downstream components to selectively skip processing of the static regions, as discussed above for example, with respect to the fifth ISRD 130e of FIG. 3.

Instructions in the ISRD 6 module 490 may be configured to receive data generated by the YUV space processing module 460 and detect zero or more static regions in a sequence of images, and configure downstream components to selectively skip processing of the static regions, as discussed above for example, with respect to the sixth ISRD 130f of FIG. 3.

Each of the ISRDs 130a-f may utilize one of an aggregated differences method, Multiple-input Signature Register (MISR) method, or keypoint extraction and matching method, discussed in more detail below. For example, in some aspects, two or more of the ISRDs 130a-f may both utilize the aggregated differences method, but using different thresholds. In some aspects, an ISRD utilizing the MISR method may be positioned later in the pipeline 100 than another ISRD utilizing the aggregated differences method, due to a higher level of noise that may be present earlier in the imaging pipeline 100.

While the device 400 is shown to include an imaging sensor 420, some aspects of the device 400 may not include an imaging sensor. In these aspects, a source for imaging data processed by the modules 434, 440, 445, 450, 455, 460, 465, 470, 475, 480, 485, and 490 may be one or more of the storage 414, and/or a network (not shown).

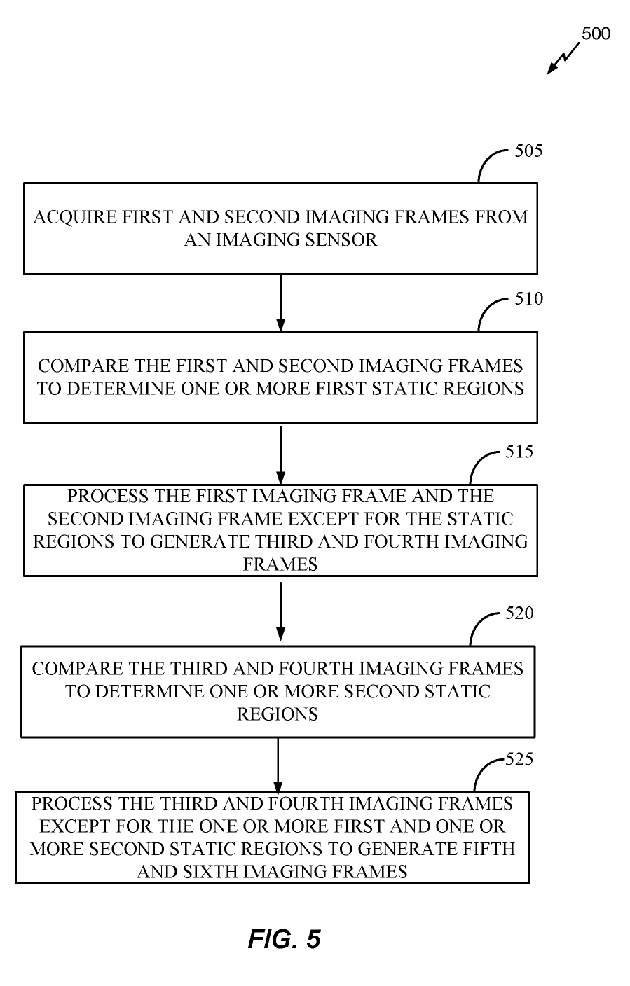

FIG. 5 is a flowchart of a method of detecting static regions in an image pipeline and as a result, saving power in some aspects. For example, FIG. 5 may describe a method for detecting static regions in the imaging pipeline 100, discussed above in FIGS. 1 and 3. As one or more static regions are detected, the static regions may not be further processed by the imaging pipeline. Because less data is processed and written to memory or stable storage during image processing, power consumption of the image pipeline may be reduced in some aspects. Static region detection performance may vary depending on the stage of the pipeline in which the static region detection is performed. For example, static region detection may perform better at later stages of the pipeline, after, for example, noise has been removed from the image. However, removing static regions from further image processing at later stages of the pipeline does not necessarily save power during earlier stage processing.

While detecting static regions in earlier stages of the pipeline may be less reliable or require more processing capability, the power savings can be more significant, as there are more pipeline stages and thus more power consuming processing steps to follow as compared to later stage detection of static regions. The disclosed methods and systems employ static region detection at least twice during the imaging pipeline, therefore potentially eliminating static regions from further processing relatively early in the pipeline, if these regions can be detected early with reasonable efficiency and efficacy, while also eliminating static regions later in the pipeline, when they can be more reliably detected, albeit with the benefit of potentially smaller savings in power.

In some aspects, process 500 discussed below with respect to FIG. 5 may be performed by the device 400 discussed above with respect to FIG. 4. For example, in some aspects, instructions in one or more of the image sensor control module 434, Bayer space processing module 440, demosaic module 445, RGB space processing module 450, color space transformation module 450, YUV space processing module 460, ISRD 1 465, ISRD 2 470, ISRD 3 475, ISRD 4 480, ISRD 5 485, or ISRD 6 490 may configure the processor 404 to perform one or more of the functions discussed below with respect to process 500.

In block 505, first and second imaging frames are acquired from an imaging sensor. In some other aspects, the first and second imaging frames may be received from a data store, such as an electronic memory or fixed stable hard disk device. In some aspects, the first and second imaging frames are received from a network. In some aspects, the first and second imaging frames may be in a Bayer format.

In block 510, the first and second imaging frames are compared to determine one or more static regions within the imaging frames. For example, in some aspects, comparison of the first and second imaging frames may include segmenting each of the first and second imaging frames into a plurality of regions. For example, FIG. 2 shows an example of segmenting two images 205 and 210 into a plurality of corresponding regions. In some aspects, differences between corresponding pixel values within a particular region may be computed and then aggregated. If the aggregated differences are above a threshold value, the particular region may be characterized as dynamic. Otherwise, the region may be characterized as static. This process may be repeated for each of the regions created by the segmentation of the first and second imaging frames. This method of static region detection may be referred to as the aggregated differences method.

In some aspects, a Multiple-input Signature Register (MISR) method may be employed to determine whether a region is static or dynamic. These aspects may utilize a type of a Linear Feedback Shift Register (LFSR). For example, the LFSR may include a single XOR or XNOR gate, with input to the gate (i.e. a region of image data) connected to several “taps” and the output connected to the input of a first flip-flop. An MISR has a similar structure, but the input to every flip-flop may be fed through an XOR/XNOR gate. Thus, an MISR will always generate an equivalent signature for a given set of input data.

An ISRD utilizing an MISR algorithm may receive pixels within a region in a sequence such as a linear raster scan sequence. The ISRD may then generate a signature value of this region, and compare the generated signature value with a signature value generated from the same region but in a different image frame. These two corresponding regions (for example, of the first and second imaging frames) may be determined to be static when the generated signatures are equivalent. An advantage of the MISR algorithm is that only the signature values may be stored, thus reducing memory requirements when compared to other methods that may store an entire image frame for later comparisons.

In block 515, the first imaging frame and the second image frame may be processed, except for the one or more first static regions detected in block 510. For example, in some aspects, block 515 may perform Bayer space processing, as shown above with respect to ISP 125a of FIG. 3, a demosaic operation, such as shown above with respect to ISP 125b of FIG. 3, RGB space processing, as discussed above with respect to ISP 125c in FIG. 3, Color Space Transformation, as discussed above with respect to ISP 125d in FIG. 3, or YUV space processing, as discussed above with respect to ISP 125e in FIG. 3. In some aspects, block 515 may process a different number of regions of the first image and second image frames. For example, the static regions detected in block 510 may not be processed in the second image frame but may be processed in the first image frame.

In some aspects, the first imaging frame and second imaging frame may be comprised of data of a first type, such as Bayer image data, RGB image data, or YUV image data. In some aspects, the first and second imaging frames may not only have a particular type, but also may have a particular representation. For example, the ISP 125b discussed above receives Bayer data and outputs data that is of type RGB, and the output data has been altered relative to the input data in that the output data references an RGB color model whereas the Bayer input data references a RAW image model of the image as captured by an imaging sensor.

As a result of the processing that occurs in block 515, third and fourth imaging frames are generated. The third imaging frame may result from processing the first imaging frame in block 515. The fourth imaging frame may result from processing the second imaging frame in block 515. In some aspects, the complete first imaging frame may be processed by block 515, including the one or more first static regions. In some aspects, the one or more first static regions of the first imaging frame may not be processed by block 515. When the second imaging frame is processed by block 515, the one or more first static regions of the second imaging frame are not processed when generating the fourth imaging frame. In some aspects, the type of data of the first imaging frame is different than the type of data of the third imaging frame. For example, the type of the first imaging frame may be Bayer data, while the type of data of the third imaging frame may be RGB data (for example, if block 515 performs a demosaic or CFA interpolation process on the first and second imaging frames).

In block 520, the third and fourth imaging frames are compared to determine one or more second static regions between the third and fourth imaging frames. In some aspects, the one or more first static regions are not subject to the comparison in block 520, as these regions may have already been characterized as static by one of the earlier stage ISRDs and their data is not processed by later stages of the imaging pipeline.

In some aspects, comparing the third and fourth imaging frames may be performed in a similar manner as that discussed above with respect to block 510 and the first and second imaging frames. In some aspects, because the type of data and quality of image frames compared in block 510 are different than the type of data and quality of image frames compared in block 520, details of the comparison may vary. For example, in some aspects, the comparison in block 520 may differ from the comparison in block 510 in that block 520 may have a different threshold from block 510 when both blocks utilize the aggregated differences method described above.

In some aspects, the third frame and fourth frame may contain less noise than the first frame and second frame, and thus, in these aspects, block 520 may utilize the Multiple-input Signature Register (MISR) method described above while block 510 may utilize the aggregated differences method discussed above to compare the first and second imaging frames, which may contain more noise than the third and fourth imaging frames in some aspects.

As the aggregated differences method may require more memory than the Multiple-input Signature Register (MISR) method, and the different data types of the earlier images may occupy different amounts of storage, block 510 and 520 may use different methods to compare image frames, especially if the image data type of the first and second imaging frames is different than the image data type of the third and fourth imaging frames.

Furthermore, in some aspects, the MISR method may be more sensitive to noise than the aggregated differences method. For example, some aspects of the MISR method may generate different signatures for corresponding regions of two imaging frames if there are any differences in the corresponding regions. The different signatures may result in a determination that the corresponding regions are dynamic. Thus, if the difference is a result of noise, an otherwise static region may not be detected via MISR in some aspects. Some aspects of the disclosed embodiments may utilize the MISR method in one of more of ISRD 3 130c, ISRD 4 130d, ISRD 5 130e and ISRD 6 130f. MISR may be suitable for these ISRDs as their input data includes three channels (R, G, B, or Y, U, V) and generally may include less noise than data processed by ISRD 1 130a and/or ISRD 2 130b. Furthermore, input data defining pixels with three values may require more local storage to store an entire image for comparison, which may be necessary to implement the aggregated differences method. Furthermore, later stage image pipeline data may include less noise, thus providing a higher probability that MISR may properly detect station regions, given its lower difference tolerance than the aggregated differences method.

In some other aspects, blocks 510 and 520 may both utilize the aggregated differences method of static region detection, but may utilize different thresholds when determining whether aggregated differences in a region are large enough to render a particular region dynamic. For example, because image data processed by block 510 may include more noise in some aspects, block 510 may utilize a higher threshold (rendering the method less sensitive to noise) while block 520 may utilize a lower threshold (allowing block 520 to be more sensitive and detect static regions that were not detected with the higher threshold of block 510 in these aspects).

In some aspects, a keypoint extraction and matching method may be employed by block 520 to detect static regions between the third and fourth imaging frames. This method may utilize scale-invariant feature transform (SIFT), Harris Corners, Maximally Stable Extremal Regions (MSER) to extract and then compare keypoints in a region of the third or fourth frames. Keypoints in some aspects may be edges detected in the image that have a signature sufficiently unique so as to enable them to be matched across different sets of imaging data. In aspects utilizing this method, a region may be considered static if extracted keypoints are equivalent across the third and fourth imaging frames. Equivalents of keypoints may be based on one or more of the relative positions of the keypoints in the images and/or relative pixel values contained within the keypoints.

The keypoint extraction and matching method may require less information/pixels to be stored when compared to the accumulated differences method. This method may also be robust in the face of image transformations, and it may be scale independent. The keypoint extraction method may in some aspects be less restrictive than the MISR method discussed above, in that some differences between the third and fourth imaging frames may still provide for a static determination when utilizing this method.

This method may be utilized in some aspects in ISRDs that are positioned in the image pipeline after scaling, edge enhancement processing, sharpening processing and other feature enhancement processing. These types of operations may occur in later pipeline stages, and therefore, this method may be employed in some aspects in ISRD 6 (130f). Other possible methods of static region detection that may be employed in various aspects include use of a hash function such as MDS. Alternatively, combinations of the above techniques may be utilized to detect static regions in some aspects.

In block 525, the third and fourth imaging frames are processed, except for the one or more first regions and the one or more second static regions to generate fifth and sixth imaging frames. For example, in some aspects, block 525 may represent a later stage ISP of an imaging pipeline 100 while block 515 represents an earlier stage ISP of the imaging pipeline 100. In some aspects, if block 515 performs Bayer space processing, as shown above with respect to ISP 125a of FIG. 3, block 525 may represent a demosaic operation, such as shown above with respect to ISP 125b of FIG. 3. In aspects where block 515 performs a demosiac operation, as shown above with respect to ISP 125b, block 525 may perform RGB space processing, as discussed above with respect to ISP 125c in FIG. 3 or ISP 125d in FIG. 3. In some aspects, where block 515 performs RGB space processing as discussed above with respect to ISP 125c in FIG. 3, block 525 may perform YUV space processing, as discussed above with respect to ISP 125d in FIG. 3. In some aspects, block 515 and 525 do not necessarily represent contiguous portions of an image processing pipeline. For example, block 515 may perform Bayer space processing as shown above with respect to ISP 125a of FIG. 3, while block 525 performs YUV space processing, as shown above with respect to ISP 125d of FIG. 3.

In some aspects, the fifth imaging frame is generated based on data in the third imaging frame while the sixth imaging frame is generated based on data in the fourth imaging frame. In some aspects, the processing of the third imaging frame does not include one or more of the first and/or second static regions. Processing of the fourth imaging frame does not include the one or more first static regions detected in block 510 nor does it include the one or more second static regions detected in block 520.

In some aspects, method 500 may utilize the aggregated differences method for static image detection in earlier pipeline stages, such as block 510, which may operate on Bayer image format. Given the aggregated differences method may have relatively large memory requirements, the Bayer image format having one component (R, G, or B) for each pixel reduces the size of the image data and reduces one disadvantage (high memory usage) associated with the aggregated differences method. ISRD's operating on non-bayer data may utilize the MISR or keypoint methods of static region detection discussed above, given the larger data size associated with the non-bayer data.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of a list of” items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method for reducing power consumption of an imaging pipeline in an imaging device, comprising:
characterizing, via an electronic hardware processor utilizing a first static region detection method, each of a plurality of regions of first imaging data as either static or dynamic;
processing the dynamic regions of first imaging data while abstaining from processing the static regions of first imaging data to generate second imaging data;
characterizing, via the electronic hardware processor using a second static region detection method different from the first static region detection method, each of a second plurality of regions of second imaging data as either static or dynamic;
processing the dynamic regions of second imaging data while abstaining from processing the static regions of second imaging data to generate third imaging data; and
writing data derived from the third imaging data to an output device.

2. The method of claim 1, wherein writing the data derived from the third imaging data to an output device comprises displaying the data derived from the third imaging data to an electronic display or writing the data derived from the third imaging data to a stable storage device.

3. The method of claim 1, wherein processing the dynamic regions of first imaging data comprises generating second imaging data as Bayer format data by performing Bayer space processing on the dynamic regions of first imaging data.

4. The method of claim 3, wherein processing the dynamic regions of second imaging data comprises generating third imaging data as RGB data by performing demosaicing on the dynamic regions of second imaging data.

5. The method of claim 1, wherein characterizing each of the plurality of regions of first imaging data as either static or dynamic comprises aggregating differences between corresponding pixels in the region data and a corresponding region in other imaging data and comparing the aggregated differences to a first threshold.

6. The method of claim 5, further comprising characterizing the region as dynamic in response to the aggregated differences exceeding the threshold and characterizing the region as static in response to the aggregated differences being below the first threshold.

7. The method of claim 6, wherein characterizing a second region of the second plurality of regions as static or dynamic comprises aggregating differences between corresponding pixels in the second imaging data and second other imaging data and comparing the aggregated differences to a second threshold different from the first threshold.

8. The method of claim 5, wherein characterizing a second region of the second plurality of regions as static or dynamic comprises:
generating a first signature based on data within the second region;
generating a second signature based on data within a third region of other imaging data corresponding to the second region; and
characterizing the second region as dynamic in response to the first signature being different from the second signature and as static in response to the first signature and second signatures being equivalent.

9. The method of claim 8, further comprising generating the first and second signatures via a multiple-input signature register (MISR) method.

10. The method of claim 5, wherein characterizing a second region of the second plurality of regions as static or dynamic comprises:
identifying keypoints in the second region;
identifying keypoints in a third region of other imaging data corresponding to the second region;
correlating the first and second keypoints; and
characterizing the second region as static or dynamic based on differences in one or more of relative positions and pixel values of the correlated keypoints.

11. The method of claim 1, wherein processing the dynamic regions of the first imaging data comprises Bayer processing of the dynamic regions and wherein processing the dynamic regions of the second imaging data comprises demosaicing of the dynamic regions of the second imaging data.

12. The method of claim 1, wherein processing the dynamic regions of the first imaging data comprises RGB space processing of the dynamic regions and wherein processing the dynamic regions of the second imaging data comprises YUV space processing of the dynamic regions of the second imaging data.

13. An imaging device providing for reduced power consumption of an imaging pipeline, comprising:
an electronic hardware processor, configured to:
characterize, using a first static region detection method, each of a plurality of regions of first imaging data as either static or dynamic;
process the dynamic regions of first imaging data while abstaining from processing the static regions of first imaging data to generate second imaging data;
characterize, using a second static region detection method different from the first static region detection method, each of a second plurality of regions of second imaging data as either static or dynamic;
process the dynamic regions of second imaging data while abstaining from processing the static regions of second imaging data to generate third imaging data; and
write data derived from the third imaging data to an output device.

14. The imaging device of claim 13, wherein the electronic hardware processor is further configured to write the data derived from the third imaging data to an output device by displaying the data derived from the third imaging data to an electronic display or by writing the data derived from the third imaging data to a stable storage device.

15. The imaging device of claim 13, wherein the electronic hardware processor is further configured to process the dynamic regions of first imaging data by performing Bayer space processing on the dynamic regions of first imaging data and generating second imaging data as Bayer format data.

16. The imaging device of claim 15, wherein the electronic hardware processor is further configured to characterize the dynamic regions of second imaging data by performing demosaicing on the dynamic regions of second imaging data and generating third imaging data as RGB data.

17. The imaging device of claim 13, the electronic hardware processor is further configured to characterize each of the plurality of regions of first imaging data as either static or dynamic by aggregating differences between corresponding pixels in the region data and a corresponding region in other imaging data and comparing the aggregated differences to a first threshold.

18. The imaging device of claim 17, wherein the electronic hardware processor is further configured to characterize the region as dynamic in response to the aggregated differences exceeding the threshold and characterize the region as static in response to the aggregated differences being below the first threshold.

19. The imaging device of claim 18, wherein the electronic hardware processor is further configured to characterize a second region of the second plurality of regions as static or dynamic by aggregating differences between corresponding pixels in the second imaging data and second other imaging data and comparing the aggregated differences to a second threshold different from the first threshold.

20. The imaging device of claim 17, wherein the electronic hardware processor is further configured to characterize a second region of the second plurality of regions as static or dynamic comprises:
generating a first signature based on data within the second region;
generating a second signature based on data within a third region of other imaging data corresponding to the second region; and
characterizing the second region as dynamic in response to the first signature being different from the second signature and as static in response to the first signature and second signatures being equivalent.

21. The imaging device of claim 20, wherein the electronic hardware processor is further configured to generate the first and second signatures via a multiple-input signature register (MISR) method.

22. The imaging device of claim 17, wherein the electronic hardware processor is configured to characterize a second region of the second plurality of regions as static or dynamic by:
identifying keypoints in the second region;
identifying keypoints in a third region of other imaging data corresponding to the second region;
correlating the first and second keypoints; and
characterizing the second region as static or dynamic based on differences in one or more of positions, and pixel values of the correlated keypoints.

23. The imaging device of claim 13, wherein processing the dynamic regions of the first imaging data comprises Bayer processing of the dynamic regions and wherein processing the dynamic regions of the second imaging data comprises demosaicing of the dynamic regions of the second imaging data.

24. The imaging device of claim 13, wherein processing the dynamic regions of the first imaging data comprises RGB space processing of the dynamic regions and wherein processing the dynamic regions of the second imaging data comprises YUV space processing of the dynamic regions of the second imaging data.

25. A non-transitory computer readable media comprising instructions that when executed cause an electronic hardware processor to perform a method of reducing power consumption by an imaging pipeline in an imaging device, the method comprising:
characterizing, via an electronic hardware processor utilizing a first static region detection method, each of a plurality of regions of first imaging data as either static or dynamic;
processing the dynamic regions of first imaging data while abstaining from processing the static regions of first imaging data to generate second imaging data;
characterizing, via the electronic hardware processor using a second static region detection method different from the first static region detection method, each of a second plurality of regions of second imaging data as either static or dynamic;
processing the dynamic regions of second imaging data while abstaining from processing the static regions of second imaging data to generate third imaging data; and
writing data derived from the third imaging data to an output device.

26. The non-transitory computer readable media of claim 25, wherein characterizing each of the plurality of regions of first imaging data as either static or dynamic comprises aggregating differences between corresponding pixels in the region data and a corresponding region in other imaging data and comparing the aggregated differences to a first threshold.

27. The non-transitory computer readable media of claim 26, the method further comprising characterizing the region as dynamic in response to the aggregated differences exceeding the threshold and characterizing the region as static in response to the aggregated differences being below the first threshold.

28. The non-transitory computer readable media of claim 27, wherein characterizing a second region of the second plurality of regions as static or dynamic comprises aggregating differences between corresponding pixels in the second imaging data and second other imaging data and comparing the aggregated differences to a second threshold different from the first threshold.

29. The non-transitory computer readable media of claim 26, wherein characterizing a second region of the second plurality of regions as static or dynamic comprises:
generating a first signature based on data within the second region;
generating a second signature based on data within a third region of other imaging data corresponding to the second region; and
characterizing the second region as dynamic in response to the first signature being different from the second signature and as static in response to the first signature and second signatures being equivalent.

30. The non-transitory computer readable media of claim 26, wherein characterizing a second region of the second plurality of regions as static or dynamic comprises:
identifying keypoints in the second region;
identifying keypoints in a third region of other imaging data corresponding to the second region;
correlating the first and second keypoints; and
characterizing the second region as static or dynamic based on differences in one or more of relative positions and pixel values of the correlated keypoints.
